(19) United States
(12) Patent Application Publication
(10) Pub. No.: US 2026/0138548 A1
(43) Pub. Date: May 21, 2026

(54) VEHICLE CRASH PROTECTION STRUCTURES

(71) Applicant: Atieva, Inc., Newark, CA (US)

(72) Inventors: Vivek Attaluri, Fremont, CA (US); Mohamed Hassan, Fremont, CA (US); Varun Sanjay Tailor, Newark, CA (US); Meng Ng, Fremont, CA (US); Zachary Mark Walker, Mountain View, CA (US); Arjun Srinath Raju, San Jose, CA (US); Vijay Shankar Authimoolam Iyer, Fremont, CA (US)

(21) Appl. No.: 18/951,564

(22) Filed: Nov. 18, 2024

(51) Int. Cl. B60R 19/34; B60R 19/26

(52) U.S. Cl. CPC B60R 19/34; B60R 2019/264

(57) ABSTRACT

An insert for a crash rail of a vehicle supports surfaces of a cell of the crash rail and accommodates a bolt assembly traversing the cell when the insert is inserted into the cell of the crash rail. A crash protection assembly for a vehicle comprises: a crash rail; a torque box; and a subframe member of a cast material that comprises: a first front node and a second front node configured for releasable attachment of the subframe member to the crash rail using bolts, each of the first front node and the second front node comprising a respective slot for engaging with a head of the bolt, the slot being open toward a front of the vehicle; and a first rear node and a second rear node, each of the first rear node and the second rear node configured for attachment of the subframe member to the torque box.

### TECHNICAL FIELD

This document relates to vehicle crash protection structures.

### BACKGROUND

Various approaches have been taken for improving a vehicle's resistance to collisions. In vehicles that have an internal combustion engine mounted at the front, the mounting of the engine and transmission may be designed to allow them to drop downward upon frontal impact, as a way of addressing crash protection. In vehicles that do not have an internal combustion engine mounted at the front, other approaches have been used. For front impact protection, some vehicle manufacturers have made use of a steel frame toward the front of the vehicle for some of the collision loads. This has required reinforcements to be made in the vehicle body, such as in the A-pillar or the rocker panel, which increases the mass of the vehicle. Another approach that has been tried is to use an aluminum frame, but this may not provide sufficient energy absorption, particularly in collisions that are not fully frontal but rather where the colliding object has only a small overlap with the vehicle. As a result, these manufacturers have chosen to add more reinforcements to the body-in-white, such as the A-pillar or the rocker panel. Some of the previous approaches for front collision protection were made from many parts, which meant that they required significant expense in assembly and material costs.

### SUMMARY

In a first aspect, an insert for a crash rail of a vehicle comprises: a first portion forming a first support surface for a cell of the crash rail; a second portion forming a second support surface for the cell; and a third portion connected to the first portion and the second portion, wherein the first support surface and the second support surface face in opposite directions from each other, and wherein the first portion, the second portion and the third portion form a slot to accommodate a bolt assembly traversing the cell when the insert is inserted into the cell of the crash rail.

Implementations can include any or all of the following features. The first portion, the second portion and the third portion are configured so the slot has substantially a U-shape. The first portion, the second portion and the third portion form a first planar side surface and a second planar side surface, the first planar side surface and the second planar side surface positioned on opposite sides of the insert from each other. The first planar side surface and the second planar side surface are substantially parallel to each other. The first support surface and the second support surface are parallel to each other and are perpendicular to each of the first planar side surface and the second planar side surface. The first portion and the second portion are configured to extend past a side of the bolt assembly that is opposite from the third portion. Each of the first support surface and the second support surface has a common length along a longitudinal axis of the cell. The first support surface is longer than the second support surface along a longitudinal axis of the cell. The insert is configured so that the first support surface substantially abuts a first inner surface of the cell that is part of an exterior of the crash rail, and so that the second support surface substantially abuts a second inner surface of the cell that is not part of the exterior of the crash rail. The insert further comprises adhesive on at least one of the first support surface or the second support surface. The adhesive is an expanding adhesive. The insert further comprises an opening configured for receiving a fastener to secure the insert within the cell. The insert further comprises at least a first rib on an inside of the first portion, and at least a second rib on an inside of the second portion, each of the insides facing the slot. The first portion has multiple ribs. The first support surface is longer than the second support surface along a longitudinal axis of the cell, and wherein the first portion has a greater number of ribs than the second portion. The insert is made from a polymer material. The polymer material comprises nylon.

In a second aspect, a crash protection assembly for a vehicle comprises: a torque box; a crash rail comprising an elongate body having an at least partially hollow interior that defines a cell, the crash rail having a front end configured for abutting a bumper beam of the vehicle, the crash rail having a rear end configured for abutting the torque box, the crash rail having openings on opposite sides of the cell adjacent the rear end; an insert assembled inside the cell at the rear end of the crash rail, the insert comprising: a first portion forming a first support surface for the cell; a second portion forming a second support surface for the cell; and a third portion connected to the first portion and the second portion, wherein the first portion; and a bolt assembly that bolts the crash rail to the torque box, the bolt assembly comprising a bolt extending through the openings and traversing the cell, wherein the second portion and the third portion of the insert form a slot to accommodate the bolt assembly.

Implementations can include any or all of the following features. The first portion, the second portion and the third portion are configured so the slot has substantially a U-shape. The first support surface and the second support surface face in opposite directions from each other. The first portion, the second portion and the third portion form a first planar side surface and a second planar side surface, the first planar side surface and the second planar side surface positioned on opposite sides of the insert from each other. The first planar side surface and the second planar side surface are parallel to each other. The first support surface and the second support surface are parallel to each other and are perpendicular to each of the first planar side surface and the second planar side surface. The first portion and the second portion are configured to extend past a side of the bolt assembly that is opposite from the third portion. Each of the first support surface and the second support surface has a common length along a longitudinal axis of the cell. The first support surface is longer than the second support surface along a longitudinal axis of the cell. The insert is configured so that the first support surface substantially abuts a first inner surface of the cell that is part of an exterior of the crash rail, and so that the second support surface substantially abuts a second inner surface of the cell that is not part of the exterior of the crash rail. The crash protection assembly further comprises adhesive on at least one of the first support surface or the second support surface. The adhesive is an expanding adhesive. The crash protection assembly further comprises an opening configured for receiving a fastener to secure the insert within the cell. The crash protection assembly further comprises at least a first rib on an inside of the first portion, and at least a second rib on an inside of the second portion, each of the insides facing the slot. The first portion has multiple ribs. The first support surface is longer than the second support surface along a longitudinal axis of the cell, and wherein the first portion has a greater number of ribs than the second portion. The insert is made from a polymer material. The polymer material comprises nylon.

In a third aspect, a crash protection assembly for a vehicle comprises: a crash rail; a torque box; and a subframe member formed as a single piece from a cast material, the subframe member comprising: a first front node and a second front node, the first front node and the second front node configured for releasable attachment of the subframe member to the crash rail using bolts, each of the first front node and the second front node comprising a respective slot for engaging with a head of the bolt, the slot being open toward a front of the vehicle; and a first rear node and a second rear node, each of the first rear node and the second rear node configured for attachment of the subframe member to the torque box.

Implementations can include any or all of the following features. The subframe member comprises a first transverse member extending between the first front node and the second front node. The first transverse member is curved in a rearward direction between the first front node and the second front node. The crash protection assembly further comprises: a second transverse member extending between the first rear node and the second rear node; a first longitudinal member extending between the first front node and the first rear node; and a second longitudinal member extending between the second front node and the second rear node. The first transverse member, the first longitudinal member, the second transverse member, and the second longitudinal member define a first opening through the subframe member. The crash protection assembly further comprises a shear plate mounted to the subframe member, wherein the shear plate covers the first opening. The first longitudinal member defines a second opening along a longitudinal axis of the first longitudinal member, the first longitudinal member including a rib positioned in the second opening, the rib extending along the longitudinal axis, wherein the shear plate covers also the second opening to form a box section. The rib has a height that is about ⅔ of a depth of the opening. The crash protection assembly further comprises initiators defined in the first longitudinal member. The initiators face in a common direction. The common direction is an upward direction. The initiators include a first initiator and a second initiator, wherein the first initiator is positioned closer to a front of the vehicle than the second initiator, and wherein the first initiator has a greater depth than the second initiator. Each of the initiators extends in a transverse direction with regard to the first longitudinal member, and wherein each of the initiators extends only partway across the first longitudinal member along the transverse direction. An opening is defined through the subframe member, the crash protection assembly further comprising a shear plate mounted to the subframe member, wherein the shear plate covers the opening. The subframe member defines respective cavities, the crash protection assembly further comprising respective cover plates mounted to the subframe member, each of the cover plates covering one of the respective cavities. Each of the cover plates is made of a material having greater strength than the shear plate. Each of the cover plates is made of steel and the shear plate is made of aluminum. The subframe member further comprises respective stiffening ribs, each of the stiffening ribs strengthening a respective one of the cavities. The crash protection assembly further comprises push blocks positioned at a rear end of the subframe member between the first rear node and the second rear node. The crash protection assembly further comprises a plate configured to provide loadpath continuity to a battery structure of the vehicle. The crash protection assembly further comprises: a bumper beam; and at each of the first front node and the second front node: a first crush can extending in a forward direction to the bumper beam; and a second crush can extending to the bumper beam in an oblique direction with regard to the first crush can. Each of the first crush can and the second crush can includes an extrusion. Each of the second crush cans is positioned outboard of the respective first crush can. The bumper beam is a lower bumper beam of the vehicle, the crash protection assembly further comprising a main bumper positioned above the lower bumper beam, wherein the crash rail abuts the main bumper. A top surface of the second crush can is positioned lower in a z-direction than a top surface of the first crush can. The crash protection assembly further comprises a plate attached to the lower bumper beam and to the main bumper. The plate is curved along the lower bumper beam. The plate includes corrugations. The subframe member further comprises first ribs that extend from i) the first crush can and the second crush can of the first front node to ii) the first crush can and the second crush can of the second front node. The subframe member further comprises second ribs that extend from i) a first edge of the subframe member that faces substantially in an x-direction to ii) a second edge of the subframe member that faces substantially in a y-direction. The subframe member further comprises third ribs, each of the third ribs extending i) from the first front node to the first rear node, or ii) from the second front node to the second rear node. The subframe member further comprises fourth ribs, the fourth ribs forming i) a first isosceles triangle having a base facing the first rear node, and ii) a second isosceles triangle having a base facing the second rear node. The subframe member further comprises fifth ribs, the fifth ribs reinforcing a rear edge of the subframe member. The crash protection assembly further comprises an insert inserted into a cell of the crash rail, the insert comprising: a first portion forming a first support surface for a cell of the crash rail; a second portion forming a second support surface for the cell; and a third portion connected to the first portion and the second portion, wherein the first support surface and the second support surface face in opposite directions from each other, and wherein the first portion, the second portion and the third portion form a slot to accommodate a bolt assembly traversing the cell. The crash protection assembly further comprises a sleeve attached inside the crash rail, wherein the first front node has the releasable attachment to the sleeve. The sleeve is a

### BRIEF DESCRIPTION OF DRAWINGS

FIG. 1 schematically shows an example of a vehicle having crash protection structures.

FIG. 2 shows a bottom view of an example of a crash protection assembly for a vehicle.

FIG. 3 shows a perspective view of another example of the crash protection assembly of FIG. 2.

FIG. 4 shows a perspective view of another example of the crash protection assembly of FIG. 2.

FIG. 5 shows a side view of an example of the crash protection assembly of FIGS. 3-4.

FIG. 6 shows a sectional side view of an example of a crash rail with inserts for crash protection.

FIGS. 7-8 show perspective views of one of the inserts of FIG. 6.

FIGS. 9-10 show perspective views of another one of the inserts of FIG. 6.

Like reference symbols in the various drawings indicate like elements.

### DETAILED DESCRIPTION

This document describes examples of systems and techniques for vehicle crash protection. In some implementations, an improved subframe member is provided that is formed as a single piece from a cast material. This can allow the subframe member to efficiently create a lower load path during frontal impact while reducing the parts count and the complexity and costs of assembly. For example, the subframe member can be designed to deform in a particular pattern so that a crash rail can absorb collision loads and thereby provide pulse relief for occupants. As another example, the subframe member can be designed to push the vehicle away from a colliding object in the event of a small-overlap impact. As a result, the subframe member can provide the requirement crash protection while not necessitating such additional reinforcements of the vehicle body (e.g., in the A-pillar or the rocker panel) that have been associated with previous approaches.

In some implementations, a crash rail of the vehicle can have an insert that improves crash performance. The insert is placed inside a cell of the crash rail and can be designed to facilitate a desired collapsing pattern of the crash rail near where the crash rail abuts a torque box of the vehicle. For example, the insert can support a rear edge of the crash rail to prevent initiation and/or bending of the rear end of the crash rail. As such, the insert can help provide stability of the joint between the crash rail and the torque box.

Examples described herein refer to a vehicle. As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle.

Examples described herein refer to a releasable attachment. As used herein, a releasable attachment provides that a first component (e.g., a subframe member) remains attached to a second component (e.g., a crash rail) during normal operation of the vehicle.

However, upon the component(s) being subjected to the levels of load typically seen in vehicle collisions, the releasable attachment allows the first component and the second component to be released from each other.

Examples described herein refer to a crash rail. As used herein, a crash rail is a component designed to be at least partially deformed in a longitudinal direction of the vehicle upon a collision. For example, the crash rail can be an extruded component (e.g., containing aluminum) having one or more internal cells.

Examples described herein refer to a crush can. As used herein, a crush can is a component designed to be at least partially deformed upon a collision. For example, the crush can be an extruded component (e.g., containing aluminum) having one or more internal cells.

Examples described herein refer to a torque box. As used herein, a torque box is a part of a vehicle body formed with a box section to resist crash loads in a collision. For example, the torque box can be configured to convey loads from a crash rail to another part of the body (e.g., a pillar base or a rocker panel).

Examples described herein refer to a vehicle coordinate system. A vehicle coordinate system can define an x-axis, a y-axis and a z-axis. The x-axis is oriented in a longitudinal direction with regard to the vehicle body and is substantially horizontal and directed forward. The y-axis is oriented in a transverse direction across the vehicle and is substantially horizontal and perpendicular to the x-axis. The z-axis is oriented in a vertical direction and is perpendicular to the x-axis and to the y-axis.

Examples described herein refer to a front, rear, top, or a bottom. These and similar expressions identify things or aspects in a relative way based on an express or arbitrary notion of perspective. That is, these terms are illustrative only, used for purposes of explanation, and do not necessarily indicate the only possible position, direction, and so on.

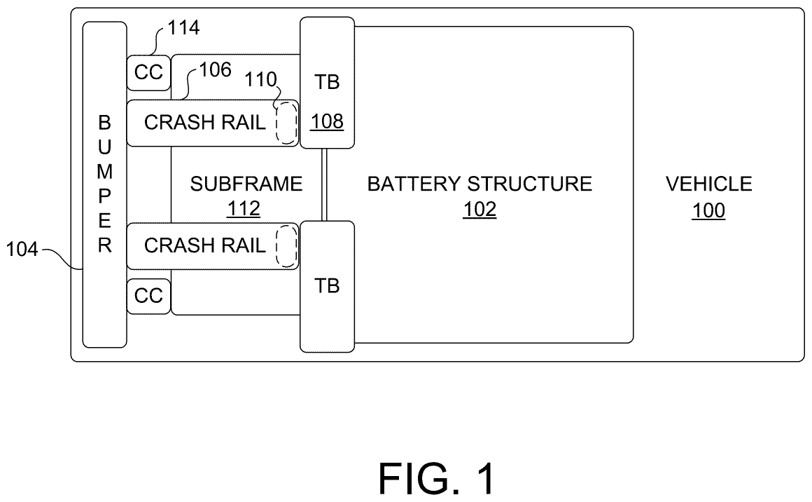

In the following description of examples, a first digit of the reference numbers generally corresponds to the number of the figure where the element is (first) shown. Thus, the 1_ series of reference numbers refers to the elements of FIG. 1, and so on.

FIG. 1 schematically shows an example of a vehicle 100 having crash protection structures. The vehicle 100 is schematically illustrated using blocks or other modular characterizations and can be used with one or more other examples described elsewhere herein. Components that are omitted for simplicity include, but are not limited to, a traction motor, wheels, a passenger compartment, electrical system, and thermal system.

The vehicle 100 includes a battery structure 102 for a battery to power one or more electric traction motors of the vehicle 100. For example, the battery structure 102 can be a battery pack or another enclosure to contain electrochemical cells. The battery structure 102 is secured to the vehicle (e.g., by being integrated into the body design).

The vehicle 100 includes a bumper 104 of metal positioned at the front. The bumper 104 is a structural component of the vehicle 100 and can be partly or entirely covered by decorative elements (e.g., fascia or other ornamentation) that are outwardly visible in the bumper area.

The vehicle 100 can have at least one crash rail 106 attached to the bumper 104. The at least one crash rail 106 can have its front end attached to the bumper 104 and extend rearward toward other structure(s). For example, the crash rail 106 is an extruded component defining one or more cells inside.

The vehicle 100 can have at least one torque box 108. In some implementations, the torque box 108 abuts a rear end of the crash rail 106 to manage crash loads. The torque box 108 forms a box section for strength. The crash rail 106 can include one or more cells. At least one cell inside the crash rail 106 can be provided with an insert 110. The insert 110 can provide stability for the crash rail 106 and/or the torque box 108. In some implementations, more than one of the cells of the crash rail 106 has a corresponding instance of the insert 110.

The vehicle 100 can have a subframe member 112 that is formed as a single piece from a cast material. The subframe member 112 can be designed to deform during a crash to allow the crash rail 106 to absorb loads.

The vehicle 100 can have a crush can 114. In some implementations, the crush can 114 is positioned between a front of the subframe member 112 and the bumper 104. For example, the crush can 114 can be an extruded member.

The vehicle 100 can have two or more instances of any component. In some implementations, the vehicle 100 can have at least two instances of each of the crash rail 106, the torque box 108, the insert 110 and the crush can 114. The respective instances can be symmetrically positioned on the sides of a longitudinal center axis of the vehicle 100. For example, two or more instances of the crush can 114 are placed on either side of the vehicle 100.

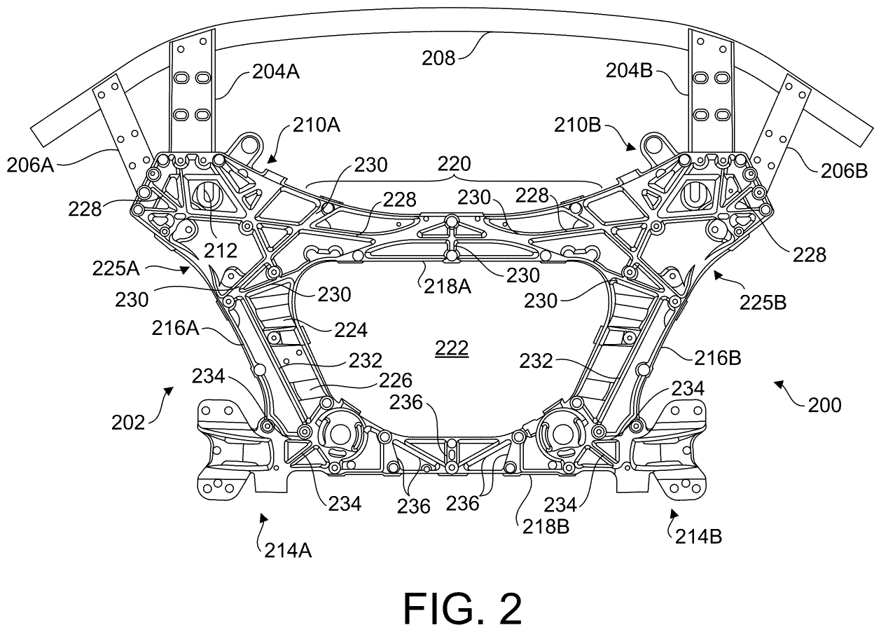

FIG. 2 shows a bottom view of an example of a crash protection assembly 200 for a vehicle. The crash protection assembly 200 can be used with one or more other examples described elsewhere herein. The crash protection assembly 200 includes a subframe member 202, crush cans 204A-204B and 206A-206B, and a bumper 208. Each of the crush cans 206A-206B is positioned outboard of the respective one of the crush cans 204A or 204B.

The crush cans 206A and 206B can be designed to provide at least crash protection in a collision where a rigid barrier collides with the vehicle while having a small overlap. The crush cans 204A and 204B can be designed to provide at least crash protection in a collision where a deformable barrier collides with the vehicle while having an overlap, as well as in a full frontal collision. The crush cans 204A-204B extend in a forward direction to the bumper 208. The crush cans 206A-206B extend in an oblique direction with regard to the crush can 204A or the crush can 204B, respectively.

The crush cans 204A-204B and 206A-206B can be bolted at their respective ends. Front ends of the crush cans 204A-204B and 206A-206B can be bolted to the bumper 208, and rear ends of the crush cans 204A-204B and 206A-206B can be bolted to a front node 210A or a front node 210B, respectively, of the subframe member 202. Each of the crush cans 204A-204B and 206A-206B can include an extrusion (e.g., including aluminum).

The subframe member 202 is formed as a single piece from a cast material. For example, the subframe member 202 can be cast as one piece from aluminum (e.g., an alloy). The subframe member 202 includes the front nodes 210A-210B. Each of the front nodes 210A-210B can be configured for releasable attachment of the subframe member 202 to a crash rail (e.g., the crash rail 106 of FIG. 1) using bolts (not shown). The releasable attachment can allow the subframe member 202 to remain attached to the crash rail during normal use (e.g., driving). In a front collision, the front nodes 210A-210B can be released from the crash rail. Here, each of the front nodes 210A-210B has a slot 212 for engaging with a head of the bolt (e.g., the bolt head being held on the proximate side of the slot 212 in the present illustration, with a remainder of the bolt extending away from the subframe member 202 at a distal side of the slot 212). The slot 212 is open toward a front of the vehicle (i.e., in a direction upward in the illustration). For example, the opening can allow the bolt head to escape the slot when the subframe member 202 is deformed in a collision.

The subframe member 202 includes rear nodes 214A-214B. Each of the rear nodes 214A-214B can be configured for attachment of the subframe member 202 to a torque box (not shown). Each of the rear nodes 214A-214B can be configured so that the subframe member 202 is able to remain attached to the torque box also during and after a front collision.

The subframe member 202 includes longitudinal members 216A-216B. The longitudinal member 216A extends between the front node 210A and the rear node 214A. The longitudinal member 216B extends between the front node 210B and the rear node 214B.

The subframe member 202 includes transverse members 218A-218B. The transverse member 218A extends between the front node 210A and the front node 210B. The transverse member 218B extends between the rear node 214A and the rear node 214B. The transverse member 218A can be curved in a rearward direction (e.g., at a portion 220) between the front node 210A and the front node 210B. For example, this curvature can be tuned to prevent fracture of the subframe member 202 in a collision where a rigid barrier collides with the vehicle while having a small overlap.

The subframe member 202 can have an opening 222. In some implementations, the opening 222 is formed by the longitudinal member 216A, the transverse member 218A, the longitudinal member 216B, and the transverse member 218B. The opening 222 can have any shape, including, but not limited to, as shown. The opening 222 can be covered. For example, a shear plate can at least partially cover the opening 222.

The subframe member 202 can have one or more initiators designed to partially or fully fracture in a collision to provide an intended deformation. Here, an initiator 224 and an initiator 226 are formed in the longitudinal member 216A. The initiator 224 is positioned forward of the initiator 226 along the longitudinal axis of the vehicle and is therefore closer to a front of the vehicle. The initiator 224 can be deeper than the initiator 226 in the z-direction. For example, in the present illustration, the initiator 224 extends deeper into the longitudinal member 216A in a direction perpendicular to the plane of the drawing, than does the initiator 226. The relatively greater depth of the initiator 224 can facilitate creation of a Z-bend drop down mode for the subframe member 202. The term Z-bend here refers to the fact that the longitudinal member 216A, which initially has a substantially linear shape, can be designed to deform into substantially a Z-shape in a collision. For example, the Z-bend drop down mode can involve that the initiator 224 fractures before the initiator 226 fractures. The relatively lesser depth of the initiator 226 can likewise facilitate creation of the Z-bend drop down mode.

The initiators 224 and 226 are here positioned on a same side of the longitudinal member 216A as each other and face in a common direction. For example, while the present illustration is a bottom view, the initiators 224 and 226 can be formed on a surface of the longitudinal member 216A that faces upward in a z-direction. The initiators 224 and 226 here extend in a transverse direction with regard to the longitudinal member 216A. Each of the initiators 224 and 226 can extend only partway across the longitudinal member 216A along the transverse direction. For example, the initiators 224 and 226 here begin at an inboard edge of the 216A and terminate about halfway through the width of the longitudinal member 216A.

The subframe member 202 can be designed to define a cavity 225A or 225B. The cavities 225A-225B can be formed to accommodate one or more vehicle components. In some implementations, a control arm 312 for the vehicle's steering, here schematically illustrated, can be housed in the cavity 225A, and a corresponding one in the cavity 225B. After the subframe member 202 is mounted to the vehicle, the control arm 312 can be assembled into its position in the cavity 225A, and correspondingly for the cavity 225B. Thereafter, each of the cavities 225A-225B can be at least partially covered, including, but not limited to, by a cover plate.

The subframe member 202 can be designed with one or more ribs for increased strength or stiffness. The ribs can be formed in the casting of the subframe member 202. The ribs can be designed to have any of various geometric shapes and/or widths or heights, for example, but not limited to, as shown.

Here, ribs 228 extend from the crush cans 204A and 206A of the front node 210A on one side of the subframe member 202 to the crush cans 204B and 206B of the front node 210B on the opposite side of the subframe member 202. As such, the ribs 228 can support the crush cans 204A-206A and 204B-206B.

Here, ribs 230 extend from an outboard edge of the longitudinal member 216A to a forward edge of the transverse member 218A. Likewise, the ribs 230 extend from an outboard edge of the longitudinal member 216B to the forward edge of the transverse member 218A. That is, the ribs 230 can extend from an edge of the longitudinal member 216A that faces substantially in an x-direction to an edge of the transverse member 218A that faces substantially in a y-direction. The ribs 230 can stabilize the transverse member 218A which is positioned at the front of the subframe member 202.

Here, ribs 232 extend along the longitudinal member 216A and the longitudinal member 216B, respectively. In some implementations, the ribs 232 can extend from the front node 210A to the rear node 214A, and correspondingly, from the front node 210B to the rear node 214B. The ribs 232 can support loading during at least a collision where a rigid barrier collides with the vehicle while having a small overlap. The height of the ribs 232 can be tuned for collision protection, for example as will be described below.

Here, ribs 234 can form an isosceles triangle having a base facing the rear node 214A, and likewise form an isosceles triangle having a base facing the rear node 214B. This triangulation can serve to pass load to the battery structure of the vehicle. Different shapes of the isosceles triangles can be used.

Here, ribs 236 can stabilize a rear end of the subframe member 202.

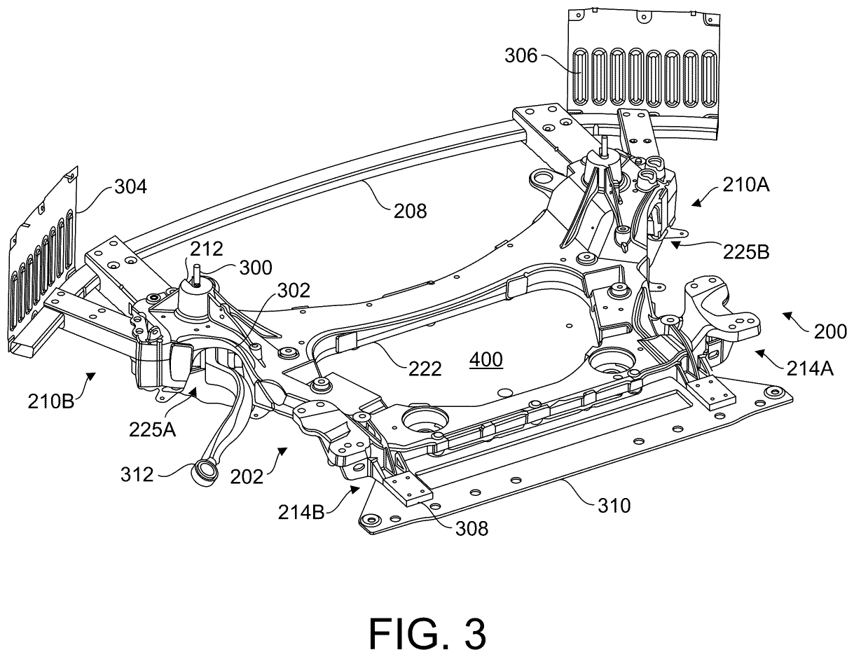

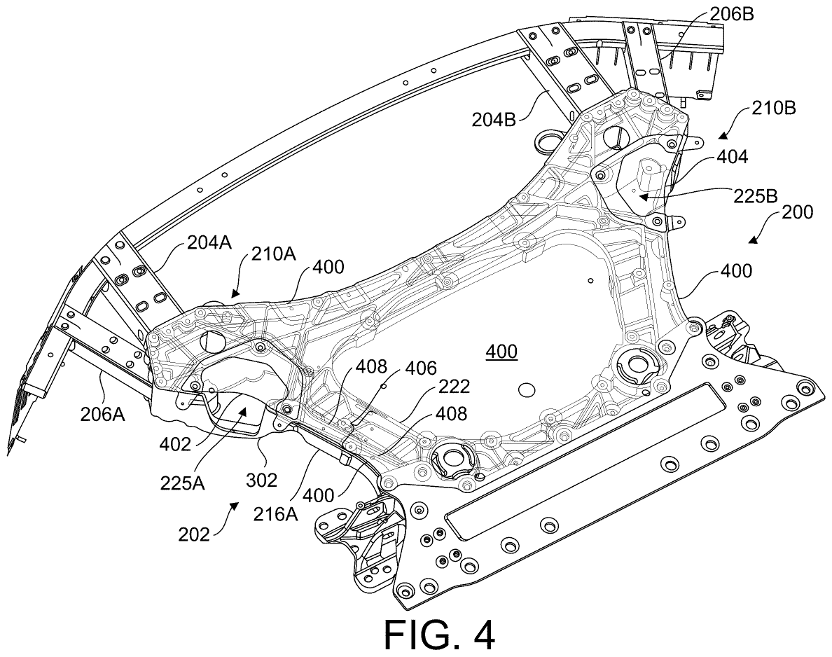

FIG. 3 shows a perspective view of another example of the crash protection assembly 200 of FIG. 2. FIG. 4 shows a perspective view of another example of the crash protection assembly 200 of FIG. 2. The perspective view of FIG. 3 is taken from above, and the one of FIG. 4 from below. Also, some components have been added compared to FIG. 2, as will be described.

A bolt 300 is here assembled to extend through each of the respective slots 212. The bolts 300 will be used for attaching the crash protection assembly 200 to a crash rail of the vehicle. As mentioned, the slots 212 have respective open ends where the bolts 300 can slide out upon the subframe member 202 undergoing deformation. This allows the end of the subframe member 202 where the front nodes 210A-210B are located to separate from the crash rail in the collision.

Each of the respective cavities 225A-225B defined by the subframe member 202 can have a stiffening rib 302 that strengthens the respective cavity 225A-225B. For example, the stiffening rib 302 can be formed as a hump or another mass of material that resists collapsing of the cavity 225A-225B.

The bumper 208 can have one or more plates 304 attached. When the bumper 208 is a lower bumper of the vehicle, the plate 304 can be designed to also be attached to a main bumper of the vehicle. This can provide increased crash protection, particularly in a collision with a moving progressive deformable barrier. When the bumper 208 is nonlinear (e.g., arced or otherwise curved), the one or more plates 304 can be curved along the bumper 208. The one or more plates 304 can include one or more corrugations 306 that can have any of various corrugation shapes.

The crash protection assembly 200 can include one or more push blocks 308 positioned at a rear end of the subframe member 202 between the rear nodes 214A-214B. A plate 310 can provide loadpath continuity to a battery structure (e.g., the battery structure 102 of FIG. 1) of the vehicle. For example, the plate 310 can be attached to the crash protection assembly 200 and also to the battery structure. The push blocks 308 may be manufactured as a component separate from the subframe member 202 (e.g., not as an integral component formed in the casting process) to streamline the assembly and disassembly. For example, having the push blocks 308 as separate components can enable removal of the crash protection assembly 200 (e.g., the subframe member 202 thereof) or the battery structure independently of the other.

A shear plate 400 is here mounted to the subframe member 202 and covers the opening 222. In FIG. 4, the shear plate 400 is shown transparent for clarity. As such, features of the subframe member 202 are seen in this illustration although covered by the shear plate 400.

The shear plate 400 can add stiffness in the x-and y-directions and help the subframe member 202 resist shear forces in those directions during a collision. By contrast, the shear plate 400 may provide relatively little resistance against deformation in the z-direction, so that the subframe member 202, including the shear plate 400, can be deformed (e.g., in the Z-bend drop down mode) during a collision. The shear plate 400 can be made of a stamped metal sheet, including, but not limited to, a relatively light metal material (e.g., including aluminum).

A cover plate 402 is here assembled to partially cover the cavity 225A. Similarly, a cover plate 404 is here assembled to partially cover the cavity 225B. In FIG. 4, the cover plates 402-404 are shown transparent for clarity. As such, features of the subframe member 202 are seen in this illustration although covered by either of the cover plates 402-404. The cover plates 402-404 can be made of a material having greater strength than the material of the shear plate 400. This strength resists the cavities against collapsing in a collision, which collapse could otherwise prevent the crush cans 204A-204B and 206A-206B from being crushed in that situation. In some implementations, each of the cover plates 402-404 is made of steel and the shear plate 400 is made of aluminum. Other materials can be used. By using the stronger material of the cover plates 402-404 only in the relatively small area where the cavities are located, and the lighter material of the shear plate 400 for a remainder of the subframe member 202, the mass of the crash protection assembly 200 can be kept lower.

The longitudinal member 216A can be designed to define an opening 406 along the longitudinal axis of the 216A. For example, respective walls at the edges of the 216A can define the opening 406 as a recessed area confined by the walls. The shear plate 400 can cover also the opening 406 to form a box section that increases the stiffness of the casting.

The longitudinal member 216A can include a rib 408 in the opening 406. The rib 408 can extend along the longitudinal axis of the longitudinal member 216A. The rib 408 can be designed as a stiffener rib to prevent fracture of the longitudinal member 216A. The rib 408 can have any of multiple heights relative to the recessed area of the opening 406. If the rib 408 is too tall, it will prevent fracturing so the vehicle exhibits too much stiffness in a full-frontal collision. On the other hand, if the rib 408 is not tall enough the subframe member 202 may fracture too easily (e.g., so that there is not sufficient push-off in the event of a small-overlap collision). In some implementations, the rib 408 extends to more than half of a depth of the opening 406. For example, the rib 408 can correspond to about ⅔ of the depth of the opening 406.

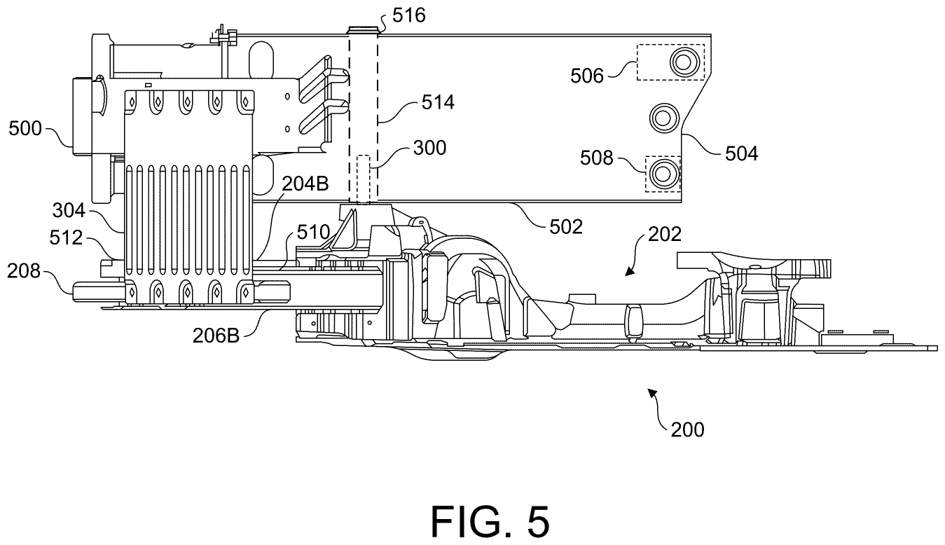

FIG. 5 shows a side view of an example of the crash protection assembly 200 of FIGS. 3-4. The crash protection assembly 200 here includes a main bumper 500; the bumper 208 can then be considered a lower bumper beam. The plate 304 is attached to both the main bumper 500 and the bumper 208. The crash protection assembly 200 includes a crash rail 502 that abuts the main bumper 500 and is designed to be deformed in a collision. A rear end 504 of the crash rail 502 can be designed to abut against a torque box of the vehicle (e.g., the torque box 108 of FIG. 1). The crash rail 502 can be an extruded component that has one or more cells inside extending substantially along the entire length of the crash rail 502. Insert 506 and insert 508 are here schematically illustrated as being positioned inside the crash rail 502 at the rear end 504. The insert 506 and/or 508 can stabilize the rear end 504 during deformation to provide improved crash protection.

The crush cans 204B and 206B are partially visible in the present illustration. The crush can 206B, which is positioned more outboard of the crush cans 204B and 206B, has a top surface 510 that is positioned lower in the z-direction than a top surface 512 of the crush can 204B. The relatively lower position of the crush can 206B to align the force that goes through the casting (e.g., the subframe member 202) during impact. Conversely, the relatively higher position of the crush can 204B can help induce bending during a full-frontal impact. For example, a Z-bend drop down mode can cause the subframe member 202 to drop out of the way to reduce deceleration.

The bolt 300 is shown in phantom extending into a sleeve 514, likewise shown in phantom, that is attached inside the crash rail 502. In some implementations, the sleeve 514 is a cylindrical sleeve. For example, a weld 516 can attach the sleeve 514 inside the crash rail 502. Accordingly, the subframe member 202 can be releasably attached to the crash rail 502. When the vehicle has at least one other crash rail in addition to the crash rail 502, a corresponding bolt-attachment assembly (e.g., another instance of the sleeve 514) can be provided inside the other crash rail.

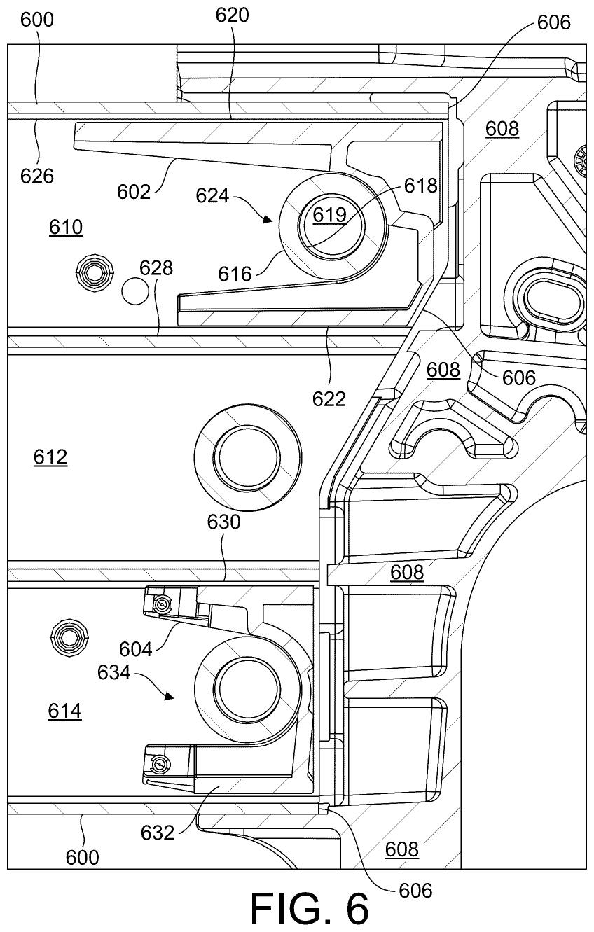

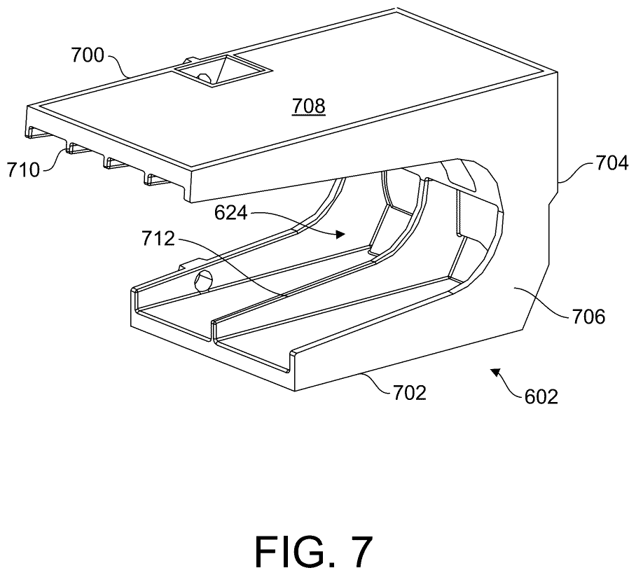

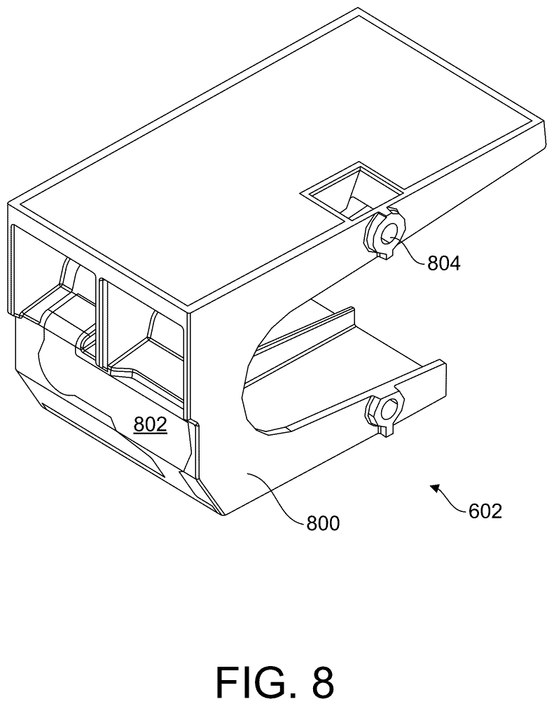

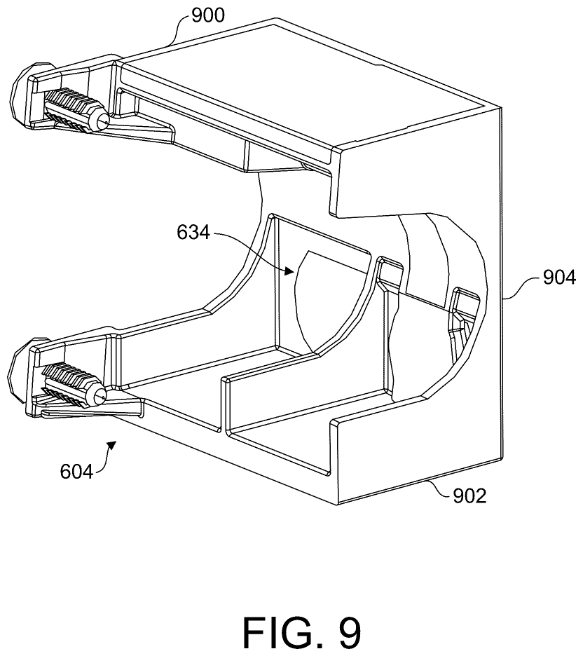

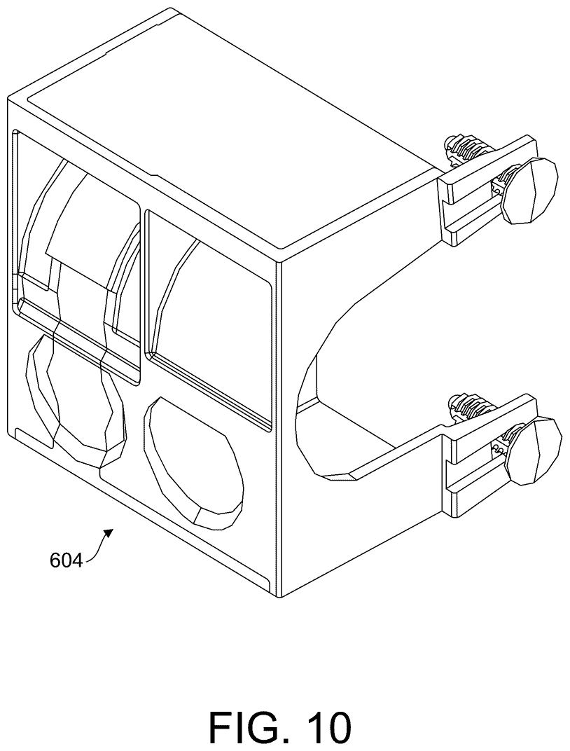

FIG. 6 shows a sectional side view of an example of a crash rail 600 with inserts 602 and 604 for crash protection. FIGS. 7-8 show perspective views of the insert 602 of FIG. 6. FIGS. 9-10 show perspective views of the insert 604 of FIG. 6. With reference briefly again to FIG. 5, the crash rail 600 can correspond to the crash rail 502, the insert 602 can correspond to the insert 506, and the insert 604 can correspond to the insert 508. The crash rail 600 has a rear end 606 that is configured to abut against a torque box 608 of the vehicle.

The crash rail 600 can define any of multiple different numbers of internal cells. Here, the crash rail 600 includes cells 610, 612 and 614 that are substantially parallel with each other. Each of the cells 610, 612 and 614 can include a corresponding instance of a sleeve 616 that is concentrically aligned with an opening 618 that passes through the cell. The opening 618 and the sleeve 616 can be designed to facilitate insertion of a bolt through the crash rail 600 (e.g., in form of a bolt assembly 619) to assemble the crash rail 600 to the torque box 608.

The insert 602 can be placed in the cell 610 at the rear end 606. Similarly, the insert 604 can be placed in the cell 614 at the rear end 606. The inserts 604-606 can include a polymer material, including, but not limited to, a nylon material.

The insert 602 can include portions 700, 702 and 704, wherein the portion 704 is connected to the portions 700-702. The portion 700 can form a support surface 620 for the cell 610. The portion 702 can form a support surface 622 for the cell 610. The support surfaces 620-622 can face in opposite directions from each other. The support surfaces 620 and 622 can be substantially parallel to each other. The portions 700, 702 and 704 can form a slot 624 to accommodate a bolt assembly 619 of the opening 618 and the sleeve 616. For example, the bolt assembly 619 can include a bolt that engages with a nut or with structure of the cell 610 or the torque box 608. The slot 624 can have substantially a U-shape. As mentioned, the bolt assembly 619 can traverse the cell 610 when the insert 602 is inserted into the cell 610 of the crash rail 600.

The slot 624 can facilitate proper positioning of the insert 602 in the cell 610. The insert 602 can be configured so that, when the insert 602 is assembled, the support surface 620 substantially abuts an inner surface 626 of the cell 610 that is part of an exterior of the crash rail 600. For example, the inner surface 626 can be the inwardly facing surface of the exterior wall of the crash rail 600. The insert 602 can be configured so that the support surface 622 substantially abuts an inner surface 628 of the cell 610 that is not part of the exterior of the crash rail 600. For example, the inner surface 626 can be part of an interior wall inside the crash rail 600.

One or both of the inserts 602-604 can have planar side surfaces. Here, the portions 700, 702 and 704 form a planar side surface 706 and a planar side surface 800. The planar side surfaces 706 and 800 are positioned on opposite sides of the insert 602 from each other. The planar side surfaces 706 and 800 can be substantially parallel to each other. The support surfaces 620 and 622 can be perpendicular to each of the planar side surfaces 706 and 800.

The portions 700 and 702 can be configured to extend past a side of the bolt assembly, the side being opposite from the portion 704. The support surfaces 620 and 622 can have the same or different lengths from each other. Here, the support surface 620 is longer than the support surface 622. For example, the additional length can allow the insert 602 to stabilize the crash rail 600 beyond an edge of the torque box 608.

One or both of the inserts 602-604 can be provided with adhesive. Here, adhesive 708 can be provided on the portions 700, and/or adhesive 802 can be provided on the portions 704, to name just two examples. The adhesive can be an expanding adhesive.

One or both of the inserts 602-604 can be designed to receive a fastener for proper positioning. Here, the insert 602 includes an opening 804 configured for receiving a fastener to secure the insert 602 within the cell 610. For example, this fastener can ensure that the insert 602 is not dislocated before the adhesive has set.

One or both of the inserts 602-604 can be provided with a rib in the slot 624. The insert 602 can have one or more ribs 710 on an inside of the portion 700, and/or one or more ribs 712 on an inside of the portion 702. The ribs 710 and 712 face the slot 624. One or both of the portions 700-702 can have more than one rib. Here, the support surface 620 is longer than the support surface 622 along the longitudinal axis of the cell 610, and the portion 700 has a greater number of ribs than the portion 702 (e.g., three ribs compared to one rib). Other approaches can be used.

Similarly, the insert 604 can include portions 900, 902 and 904, wherein the portion 904 is connected to the portions 900-902. The portion 900 can form a support surface 630 for the cell 614. The portion 902 can form a support surface 632 for the cell 614. The support surfaces 630-632 can face in opposite directions from each other. The support surfaces 630 and 632 can be substantially parallel to each other. The portions 900, 902 and 904 can form a slot 634 to accommodate the bolt assembly of the cell 614. The slot 634 can have substantially a U-shape. The support surfaces 630-632 have a common length along a longitudinal axis of the cell 614.

The above examples illustrate that an insert (e.g., the insert 602 or 604) for a crash rail of a vehicle can include: a first portion (e.g., the portion 700 or portion 900) forming a first support surface (e.g., the support surface 620 or support surface 630) for a cell (e.g., the cell 610 or the cell 614) of the crash rail; a second portion (e.g., the portions 702 or the portions 902) forming a second support surface (e.g., the support surface 622 or support surface 632) for the cell; and a third portion (e.g., the portions 704 or portions 904) connected to the first portion and the second portion, wherein the first support surface and the second support surface face in opposite directions from each other, and wherein the first portion, the second portion and the third portion form a slot (e.g., the slot 624 or slot 634) to accommodate a bolt assembly traversing the cell when the insert is inserted into the cell of the crash rail.

The above examples also illustrate that a crash protection assembly for a vehicle can include: a torque box (e.g., the torque box 108 or 608); a crash rail (e.g., the at least one crash rail 106, 502 or 600) comprising an elongate body having an at least partially hollow interior that defines a cell (e.g., the cells 610, 612 or 614), the crash rail having a front end configured for abutting a bumper beam (e.g., the bumper 104 or main bumper 500) of the vehicle, the crash rail having a rear end (e.g., the rear end 606) configured for abutting the torque box, the crash rail having openings (e.g., the opening 618) on opposite sides of the cell adjacent the rear end; an insert (e.g., the insert 602 or 604) assembled inside the cell at the rear end of the crash rail, the insert comprising: a first portion forming a first support surface for the cell; a second portion forming a second support surface for the cell; and a third portion connected to the first portion and the second portion, wherein the first portion; and a bolt assembly that bolts the crash rail to the torque box, the bolt assembly comprising a bolt extending through the openings and traversing the cell, wherein the second portion and the third portion of the insert form a slot to accommodate the bolt assembly.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1-35. (canceled)

36. A crash protection assembly for a vehicle, the crash protection assembly comprising:
a crash rail;
a torque box; and
a subframe member formed as a single piece from a cast material, the subframe member comprising:
a first front node and a second front node, the first front node and the second front node configured for releasable attachment of the subframe member to the crash rail using bolts, each of the first front node and the second front node comprising a respective slot for engaging with a head of the bolt, the slot being open toward a front of the vehicle; and
a first rear node and a second rear node, each of the first rear node and the second rear node configured for attachment of the subframe member to the torque box.

37. The crash protection assembly of claim 36, wherein the subframe member comprises a first transverse member extending between the first front node and the second front node.

38. The crash protection assembly of claim 37, wherein the first transverse member is curved in a rearward direction between the first front node and the second front node.

39. The crash protection assembly of claim 37, further comprising:
a second transverse member extending between the first rear node and the second rear node;
a first longitudinal member extending between the first front node and the first rear node; and
a second longitudinal member extending between the second front node and the second rear node.

40. The crash protection assembly of claim 39, wherein the first transverse member, the first longitudinal member, the second transverse member, and the second longitudinal member define a first opening through the subframe member.

41. The crash protection assembly of claim 40, further comprising a shear plate mounted to the subframe member, wherein the shear plate covers the first opening.

42. The crash protection assembly of claim 41, wherein the first longitudinal member defines a second opening along a longitudinal axis of the first longitudinal member, the first longitudinal member including a rib positioned in the second opening, the rib extending along the longitudinal axis, wherein the shear plate covers also the second opening to form a box section.

43. The crash protection assembly of claim 42, wherein the rib has a height that is about ⅔ of a depth of the opening.

44. The crash protection assembly of claim 39, further comprising initiators defined in the first longitudinal member.

45. The crash protection assembly of claim 44, wherein the initiators face in a common direction.

46. The crash protection assembly of claim 45, wherein the common direction is an upward direction.

47. The crash protection assembly of claim 44, wherein the initiators include a first initiator and a second initiator, wherein the first initiator is positioned closer to a front of the vehicle than the second initiator, and wherein the first initiator has a greater depth than the second initiator.

48. The crash protection assembly of claim 44, wherein each of the initiators extends in a transverse direction with regard to the first longitudinal member, and wherein each of the initiators extends only partway across the first longitudinal member along the transverse direction.

49. The crash protection assembly of claim 36, wherein an opening is defined through the subframe member, the crash protection assembly further comprising a shear plate mounted to the subframe member, wherein the shear plate covers the opening.

50. The crash protection assembly of claim 49, wherein the subframe member defines respective cavities, the crash protection assembly further comprising respective cover plates mounted to the subframe member, each of the cover plates covering one of the respective cavities.

51. The crash protection assembly of claim 50, wherein each of the cover plates is made of a material having greater strength than the shear plate.

52. The crash protection assembly of claim 51, wherein each of the cover plates is made of steel and the shear plate is made of aluminum.

53. The crash protection assembly of claim 50, wherein the subframe member further comprises respective stiffening ribs, each of the stiffening ribs strengthening a respective one of the cavities.

54. (canceled)

55. (canceled)

56. The crash protection assembly of claim 36, further comprising:
a bumper beam; and
at each of the first front node and the second front node:
a first crush can extending in a forward direction to the bumper beam; and
a second crush can extending to the bumper beam in an oblique direction with regard to the first crush can.

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. The crash protection assembly of claim 36, further comprising an insert inserted into a cell of the crash rail, the insert comprising:
a first portion forming a first support surface for a cell of the crash rail;
a second portion forming a second support surface for the cell; and
a third portion connected to the first portion and the second portion, wherein the first support surface and the second support surface face in opposite directions from each other, and wherein the first portion, the second portion and the third portion form a slot to accommodate a bolt assembly traversing the cell.

70. (canceled)

71. (canceled)
